(19) United States
(12) Patent Application Publication
(10) Pub. No.: US 2020/0213444 A1
(43) Pub. Date: Jul. 2, 2020

(54) SYSTEMS AND METHODS FOR FRACTIONAL JOB DISTRIBUTION

(71) Applicant: SINGLECOMM LLC, Richmond, VA (US)

(72) Inventors: CIPRIAN DOSOFTEI, ATLANTA, GA (US); VINCENT GREBAS, RICHMOND, VA (US)

(21) Appl. No.: 16/731,940

(22) Filed: Dec. 31, 2019

Related U.S. Application Data
(60) Provisional application No. 62/787,032, filed on Dec. 31, 2018.
(60) Provisional application No. 62/787,022, filed on Dec. 31, 2018.

(51) Int. Cl. H04M 3/51; G06Q 10/06; H04M 3/523; H04L 29/08; H04L 29/06

(52) U.S. Cl. CPC H04M 3/5141; G06Q 10/063114; G06Q 10/063112; H04M 3/5175; H04M 3/5191; H04L 65/403; H04M 3/5158; H04L 67/24; H04L 67/02; H04L 65/608; H04M 3/5233

(57) ABSTRACT

A method, system, apparatus, means and computer program products are provided that include identifying a job to be delivered to an agent, the job having a job utilization value and the agent having an available agent utilization where the available agent utilization is greater than the job utilization value, initiating a delivery process to deliver the job to the agent, and delivering the job to the agent and reducing the available agent utilization by the job utilization value.

### RELATED APPLICATIONS

This application is based on and claims priority to and benefit of U.S. Provisional Patent Application Ser. Nos. 62/787,032 and 62/787,022 filed on Dec. 31, 2018, the contents of which are each incorporated by reference herein in their entirety for all purposes.

### BACKGROUND

Many businesses operate contact centers to interact with customers and potential customers. Often, dozens or hundreds of contact center agents may be engaged in one or more campaigns on behalf of a business. These centers commonly operate or use software systems designed to distribute calls among agents. These systems are commonly referred to as “automated call distribution” systems (or “ACDs”). These ACDs were configured to route calls to an appropriate and available agent (where “available” meant that the agent was not on another call or in a status in which the agent was unable to take a call).

In previous systems, the agents were connected to the ACD via a phone call. For example, in many previous systems, agents dialed into the ACD to register their connection, and the ACD was able to determine the agent's status based on the status of the agent's phone connection to the ACD (e.g., if the agent were on another call, the ACD would be aware of it because the phone connection between the agent and the ACD would be in use).

Businesses are beginning to support other communication channels as their customers wish to communicate with them in different ways. Unfortunately, businesses typically need to use different software systems to support these other modes of communication. It would be desirable to distribute different types of communications using a common routing mechanism. Many of these different types of communications can be handled by agents who are multitasking—for example, an agent handling customer service issues via email may interact with multiple customers at the same time, while an agent who is handling customer service issues via phone may only be able to interact with a single customer at a time.

Advances in communication and computing have presented new opportunities for connecting businesses with their customers and potential customers. It would be desirable to provide improved distribution systems and methods which allow communications to be routed to and among agents who do not have a phone connection with an ACD or for new communication channels (such as Webchat, messaging, email, or the like). Applicants have further recognized that it is desirable to improve the distribution of different types of communications to maximize the amount of time that agents are utilized or productive.

### SUMMARY

Applicants have recognized that there is a need for systems, methods, apparatus, computer program code and means may provide a tool to facilitate the fractional distribution of jobs. Pursuant to some embodiments, systems, methods, apparatus, computer program code and means are provided that include identifying a job to be delivered to an agent, the job having a job utilization value and the agent having an available agent utilization where the available agent utilization is greater than the job utilization value, initiating a delivery process to deliver the job to the agent, and delivering the job to the agent and reducing the available agent utilization by the job utilization value.

Pursuant to some embodiments the delivery process further includes triggering a job monitoring process, monitoring a status of the job and a status of the agent, determining whether the job has been successfully delivered to the agent, and completing the job monitoring process. In some embodiments, the delivery process further includes establishing a timeout period for the job monitoring process and requeuing the job if the timeout period expires prior to determining whether the job has been successfully delivered to the agent.

In some embodiments, the available agent utilization is not reduced by the job utilization value if the timeout period expires prior to determining whether the job has been successfully delivered to the agent.

In some embodiments, identifying a job to be delivered to an agent further includes identifying a utilization change event associated with the agent determining that the job is an available job that the agent is qualified to handle.

In some embodiments, the utilization change event is the completion of a job resulting in an increase in the agent's available agent utilization.

A technical effect of some embodiments is an improved and computerized method to distribute jobs. More particularly, embodiments allow jobs to be distributed to agents based on the agent's capacity to be utilized. That is, embodiments allow jobs to be distributed and assigned to agents based on the nature of the job and the qualifications of the agent, resulting in implementations which allow agents to handle multiple jobs at the same time, and also allows distribution to occur when an agent's capacity frees up. The result is a highly efficient distribution system that ensures that agent utilization is maximized. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is block diagram overview of a system according to some embodiments of the present invention.

FIG. 2 illustrates a method that might be performed in accordance with some embodiments.

FIG. 3 illustrates a method that might be performed in accordance with some embodiments.

FIG. 4 illustrates a method that might be performed in accordance with some embodiments.

FIG. 5 illustrates a method that might be performed in accordance with some embodiments.

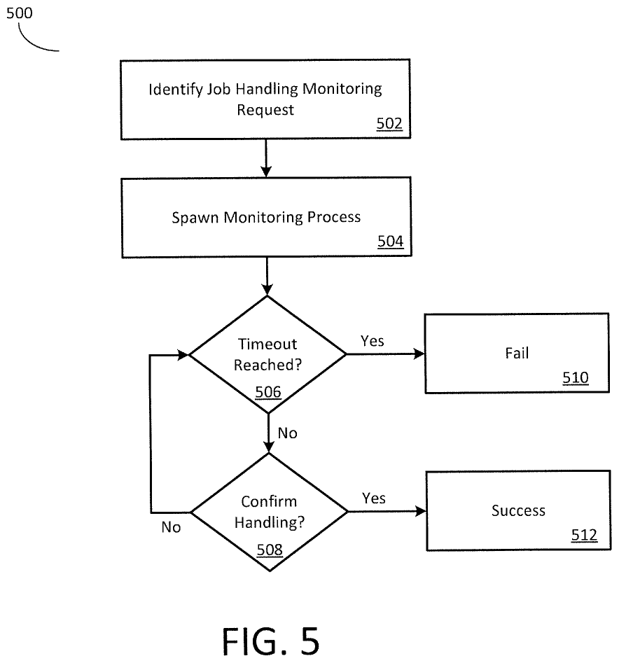

FIG. 6 illustrates an agent interface display according to some embodiments of the present invention.

FIG. 7 illustrates a method that might be performed in accordance with some embodiments.

### DESCRIPTION

For convenience and ease of exposition, a number of terms are used herein. For example, the term “job” is used to refer to an item of work or task to be performed by an agent or other user of the system of the present invention. Different types of “jobs” include, for example, a job to handle an inbound or outbound phone call, a job to handle a response to an email, a job to handle a chat interaction, a job to handle an SMS or text message interaction. In some embodiments, jobs are communication tasks that are assigned or matched with an agent to handle. In some embodiments, jobs are pieces or items of work to be handled by an agent. For example, a job may also be a translation task (e.g., where a qualified agent is asked to translate a piece of text or a call recording and to enter the translation into a web form or other location). As still another example, a job may be a task requiring a qualified agent to identify or classify an image or video. In general, a job may be any piece of work or task that an agent may handle at a workstation, mobile device, or other device using the job distribution techniques described herein. As will be described further herein, embodiments allow jobs to be matched to qualified agents having sufficient utilization available ensuring jobs are handled appropriately and timely.

As another example, the term “agent” refers to an individual or other entity that is assigned jobs using the system of the present invention. For example, an agent may be a call center employee who is responsible for handling phone calls or other jobs distributed pursuant to the present invention. As another example, an agent may be an automated attendant that is tasked with handling jobs distributed pursuant to the present invention. Other features of “agents” will be described further herein or will become apparent to those skilled in the art upon reading the following disclosure.

As another example, the term “call center” or “contact center” may be used interchangeably herein and refer to groups or associations of agents that are responsible for handling jobs for a common employer or entity. The jobs may be on behalf of third parties or the common entity. Call center agents may be located in one or more common facilities or may be distributed (e.g., working from home).

As used herein, the term “utilization” refers to an amount (e.g., as a percentage or fractional amount) that expresses how “busy” or “utilized” an agent is at any given point in time (or, in some embodiments, over a period of time. An agent who is 100% utilized during an hour of work was productively working on jobs for all 60 minutes of that hour. Unfortunately, as Applicants have discovered, an agent may be busy for 60 minutes of an hour but still not be as productive or fully utilized as they could be. For example, an agent may be busy responding to texts or chat messages during the hour, but might be underutilized if the agent was only handling a single messaging conversation at a time. As will be described further herein, embodiments allow agents to be fully utilized at any given point in time, and the term “utilization” will generally refer to an agent's current utilization or the agent's capacity to be utilized at a point in time.

The term “channel” is used herein to refer to a communication channel or mode of communication associated with a job. Illustrative examples of channels that may be used with embodiments of the present invention include (but are not limited to) voice, Web chat, text messaging via short message service (“SMS”), text messaging via multimedia messaging service (“MMS”), messaging via over the top (“OTT”) messaging applications, email, faxes, video chat or video messaging, or the like.

The term “end user” or “target” may be used interchangeably herein and is used to refer to individuals or other entities with which an agent communicates or interacts. For example, an end user may call a phone number and the call (a “job”) may be assigned to a specific agent so the agent can communicate with the end user. An end user or target may interact with agents over a variety of “channels” as discussed herein.

As used herein, the terms “campaign” or “program” generally refer to a specific project or grouping of jobs. For example, a “campaign” may include all interactions associated with a specific product or service.

A call center (e.g., such as an inhouse call center of an enterprise or an outsource call center handling interactions on behalf of one or more enterprises) may initiate or receive interactions with end users for various reasons (e.g., to purchase products, to receive help, or the like). Moreover, a call center may have a large number of agents responsible for handling these interactions. Each of those agents may have different skills, experience, and qualifications. For example, one agent might speak Spanish while another agent speaks English. One agent may be qualified to answer questions about a first product (e.g., in a first “campaign”), while another agent may only be qualified to answer questions about a second product (e.g., in a second “campaign”). Further, different campaigns, products or types of interactions may be more important than other campaigns, products or interactions. As an even further complication, interactions over some channels may be capable of being handled differently than interactions over other channels. For example, agents may only be able to handle one voice interaction at a time, while they may be able to handle several chat or messaging interactions at a time. Thus, the dissemination or routing of these interactions or jobs is a complex problem.

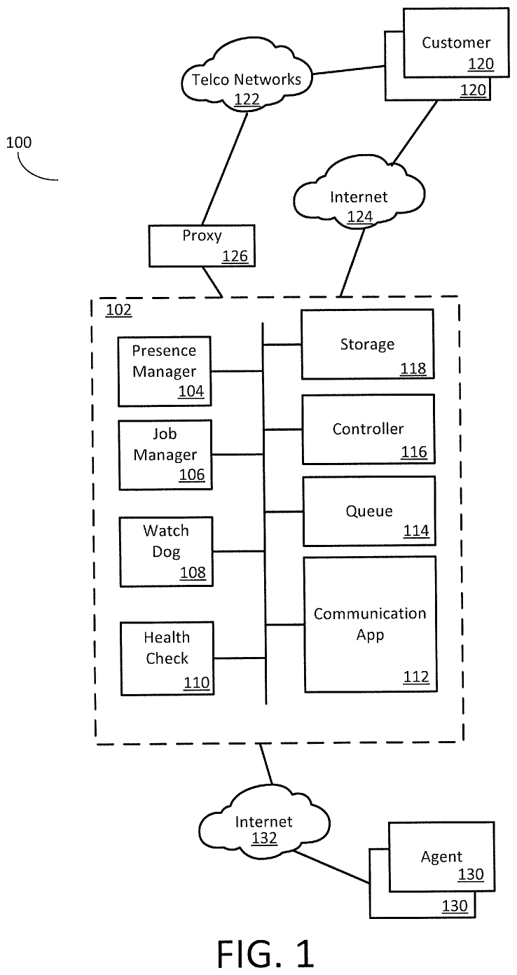

FIG. 1 is block diagram of a system 100 according to some embodiments of the present invention that enables accurate and efficient distribution of jobs to agents. In particular, system 100 includes a communications platform 102 that receives incoming communications from customers operating customer devices 120 and distributes those communications (e.g., as “jobs”) to appropriate agents operating agent devices 130. The communications platform 102 also facilitates outbound communications in which agents operating agent devices 130 are put into communication with customers operating customer devices 120. These outbound communications are distributed (e.g., as “jobs”) to appropriate agents operating agent devices 130 prior to communication with the customer.

The communications platform 102 might be, for example, associated with a Personal Computers (PC), laptop computer, an enterprise server, a server farm, and/or a database or similar storage devices. The communications platform 102 may, according to some embodiments, be associated with a single entity or a number of entities (e.g., the platform may be operated as a platform as a service on behalf of a number of entities).

Communications between the platform 102 and customers operating customer devices 120 may be via a number of different communications channels. For example, in some embodiments, customers operate customer devices 120 that are telephones (such as landlines or mobile phones). In such situations, some or all of the communication between the platform 102 and the customer may be over telco networks 122. The telco networks 122 may be or include, for example, the Public Switched Telephone Network (“PSTN”). Note that any embodiments described herein may also be associated with Internet telephony (referred to herein generally as “VoIP”). According to some embodiments, VoIP communications are implemented using session protocols such as those defined in the “Session Initiation Protocol” (or “SIP”) which is defined in RFC-3261, “SIP: Session Initiation Protocol” which is hereby incorporated by reference for all purposes.

In some embodiments, a proxy 126 may be positioned between the telco networks 122 and the platform 102. For example, the proxy 126 may be used to perform load balancing or other functions to ensure high availability of the platform 102. In some embodiments, proxy 126 may be used to perform routing to different communication applications 110 where a distributed application environment is used.

Some communications between the platform 102 and customers operating customer devices 120 may be via the Internet 124. For example, in some embodiments, customers may operate mobile devices, personal computers or other devices operating browser software that allows the customer to interact with platform 102 via Web chat channels. As another example, in some embodiments, customers may operate mobile devices or other computing devices that are configured with applications allowing over the top (“OTT”) communications with platform 102. Examples of such applications include WeChat® (offered by Tencent Corp.), Facebook Messenger® (offered by Facebook, Inc.), email applications, or the like.

Similarly, communications between the platform 102 and agents operating agent devices 130 may be via a number of different communications channels. For example, agent devices 130 may be in communication with the platform via the Internet 132 or via telco networks (not shown in FIG. 1).

The communications between customer devices 120 and platform 102 and between platform 102 and agent devices 130 may be over a number of different network protocols. For example, some communications may occur using the Transmission Control Protocol/Internet Protocol (TCP/IP), the User Datagram Protocol/Internet Protocol (UDP/IP), the real-time Transport Protocol (RTP), and the Session Initiation Protocol (SIP). As an example, some voice communications (delivered pursuant to the WebRTC protocol to an agent at an agent device 130) may use the UDP protocol in order to reduce latency.

As used herein, devices, including those associated with the communications platform 102 and any other device described herein, may exchange information via any communication network which may be one or more of a telephone network, a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

In some embodiments, the components, devices or services shown as part of communications platform 102 may be hosted in a cloud computing environment such as, for example, the environment provided by Amazon Web Services (“AWS”). In some embodiments, some or all of the components, devices or services shown as part of communications platform 102 may be hosted or deployed in an on-premise data center. Some of the components, such as, for example, the presence manager 104, the job manager 106, the watch dog 108 and the health check 110 may be a plurality of software processes that work in conjunction with other components of the system 100 to perform the functions described herein. In some embodiments, the components 104, 106, 108 and 110 may be configured as services that respond to requests or commands from other components of the system. Some or all of the components may be written in programming languages such as Python, PhP, NodeJS, or the like.

Pursuant to some embodiments, the presence manager 104 may be configured to detect, track and monitor presence or status information associated with agent devices 130 as will be described further herein. In some embodiments, presence manager 104 may work in conjunction with queue 114 to receive information published by Web browsers associated with agent devices 130 regarding the status of those devices and their associated agents. Preferably, the agent status information is published or transmitted using web sockets or other techniques that allow near real-time status and presence information to be communicated to the presence manager 104.

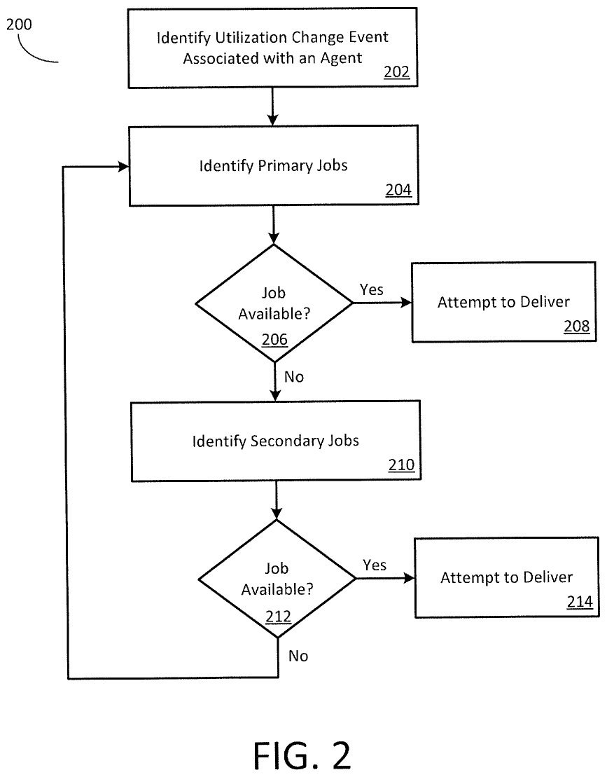

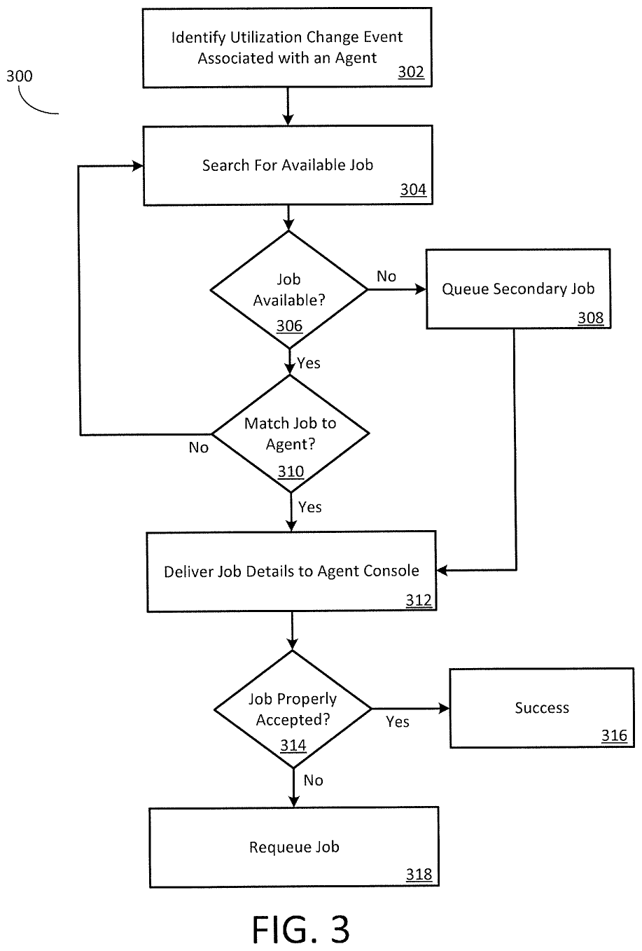

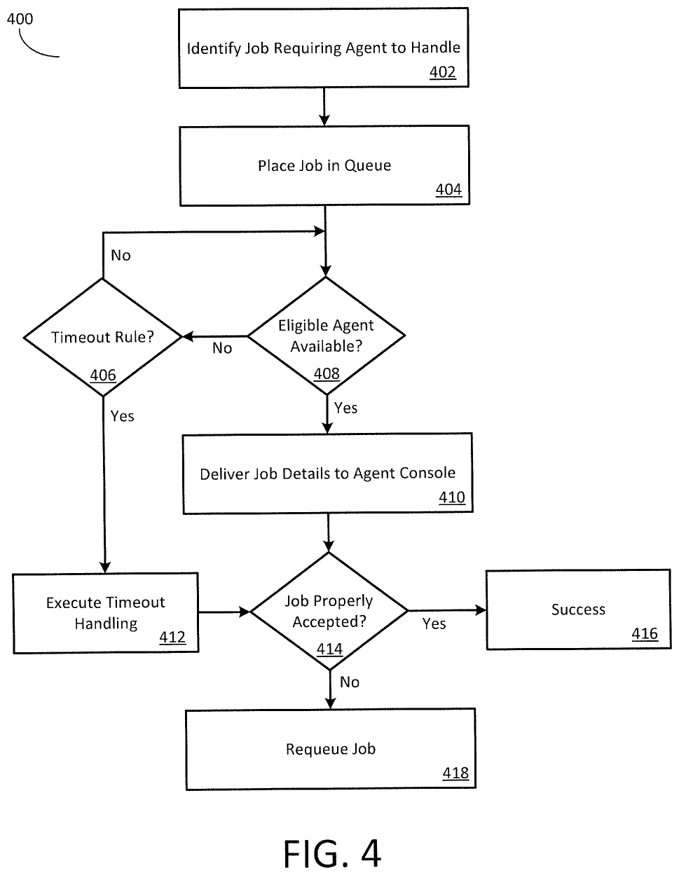

Pursuant to some embodiments, the job manager 106 is configured to perform processing to assign jobs to different agents as described in more detail herein. In some embodiments, the job manager 106 operates to assign jobs to agents whose presence or status has changed (e.g., as described in FIGS. 2 and 3 and elsewhere herein). In some embodiments, the job manager 106 operates to assign agents to jobs as described in FIG. 4 and elsewhere herein. In some embodiments, the job manager 106 is in communication with other components of system 100. For example, job manager 106 may interact with presence manager 104 to identify agent status or utilization change events. In particular, pursuant to some embodiments, utilization is a property of an agent. For example, an agent may be completely utilized (e.g., expressed as a 1 or a percentage or other numeric), an agent may be partially utilized (e.g., the agent may be 0.5 utilized or 50% utilized), or an agent may not be utilized (e.g., the agent may be 0.0 utilized or 0% utilized). In some situations, an agent may be both not utilized and have a status of not available (e.g., the agent may be on a break). The amount that an agent is currently utilized is generally referred to as the agent's “agent utilization” while the amount that an agent is currently available (or under-utilized) is generally referred to herein as the agent's “available utilization”.

As agents now have a property referred to herein as their “utilization” or the “agent utilization”, jobs now have a utilization attribute identifying how much agent utilization is required for the job (referred to herein as the “job utilization value”). As an example, a voice phone call may require an agent's full attention and thus may have a job utilization value of 1 (or 100%), while a customer service chat message job may not require the agent's full attention and thus may have a job utilization value of 0.25 (or 25%) indicating that agents can handle four such chats in parallel. Pursuant to some embodiments, jobs may inherit the job utilization value if not expressly set. For example, the job utilization value may be set at a campaign or program level so that all messaging jobs in a customer service campaign may be configured with a job utilization value of 0.25 unless overridden on a per job basis. As another example, an agent who is handling a job having a utilization value of 0.25 will have an available utilization of 0.75 and may handle one or more additional jobs so long as the job utilization value(s) of those additional job(s) is less than or equal to 0.75.

Job manager 106 may also interact with watch dog 108 to perform job assignment monitoring tasks as described further herein. As another example, job manager 106 may interact with data storage 118 to retrieve information about agent skills or capabilities or about program characteristics or the like. In some embodiments, the presence manager 104 and the job manager 106 may be combined in a single module or set of components.

Pursuant to some embodiments, health check 110 may perform processing to detect, track and monitor the status of different components of the platform 102. For example, in some embodiments, where components such as the presence manager 104 and/or the job manager 106 are deployed as services or microservices, the health check 110 may detect when one or more of those services or microservices are unavailable and may cause additional replicas or replacements of those services to be brought online or otherwise made available.

Platform 102 may also include one or more communication applications 112 which are configured to perform different types of communication processing. For example, in some embodiments, communication applications 112 may include one or more application servers that facilitate communication such as the open source FreeSWITCH switching server that supports voice and other communications or the Asterisk phone switch that supports voice communications. Other voice, chat, email and other messaging servers may also be included in or part of communications applications 112. Communications applications 112 may also include computer program code configured to control each of the messaging and communications servers to allow calls, messages or the like to be routed to agents under control of the job manager 106 as described further herein.

Reference is now made to FIG. 2, where a flow chart of a process 200 that may be implemented using the system of FIG. 1 is shown. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

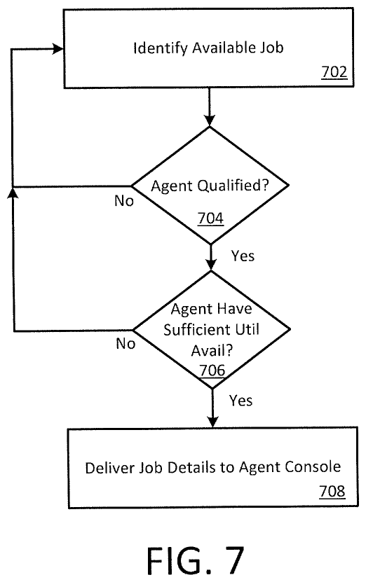

The process 200 begins at 202 where the system identifies or receives information identifying a utilization change event associated with an agent. For example, the agent may be an agent operating an agent device 130. The agent device 130 is in communication with communications platform 102. For example, the agent device 130 may be a computer having a Web browser that points to a URI associated with the system 102 of FIG. 1. One such agent interface is shown in FIG. 7 and is described further below. The agent may have a status (which may be indicated on the agent interface as shown in FIG. 7). The status may change as the agent conducts tasks or as the agent manually selects a status (for example, the agent may choose to go on a break, or the agent may return from a break and become available, etc.). Some changes in status signify a change in the agent's utilization status. That is, an agent may go from a status indicating they are unavailable to handle a job to a status indicating that they are now able to handle a job. In some embodiments, this status information is published by the Web browser associated with the agent as a web socket status message that is received by the platform 102. In some embodiments, the status message is published to a queue or queuing system 114 of the platform 102. Processing at 202 includes receipt or identification of the utilization change event associated with the agent by a job manager 106 and/or a presence manager 104.

Processing continues at 204 where the job manager 106 uses information associated with the utilization change event (including, for example, information identifying the agent) to attempt to identify one or more jobs that are available for assignment. In some embodiments, as will be discussed further herein, jobs may be presented in a queue or queuing system (such as queue 114) with information identifying the job (such as a job ID which may be formed as a UUID or the like). The queue 114 may store additional information about the job (or provide information to perform a lookup to obtain the additional information). For example, additional information may be provided for identifying the job type (e.g., such as “inbound call”, “outbound call”, “chat”, “email”, “Facebook Message”, etc.), information identifying the status of the job (e.g. such as “queued”, “routed”, “timed out”, “accepted”, “done”, “dispositioned”, or the like), time stamps indicating when the job was created and updated, and information identifying the campaign and or program the job is associated with. Further, pursuant to some embodiments, each job will have a job utilization value associated with it identifying the amount of agent utilization availability required to handle the job.

Other information may also be provided identifying whether the job has been suspended or is no longer active. As an example, a job that is available for assignment may be one where active=true, suspended=false, and status=queued. There may be a number of jobs that meet these criteria and a selection approach may be used which follows a first-in-first-out (“FIFO”) method (i.e., the job created earliest is the first job assigned) or one that follows a FIFO method with other criteria (such as a campaign or program weighting or the like).

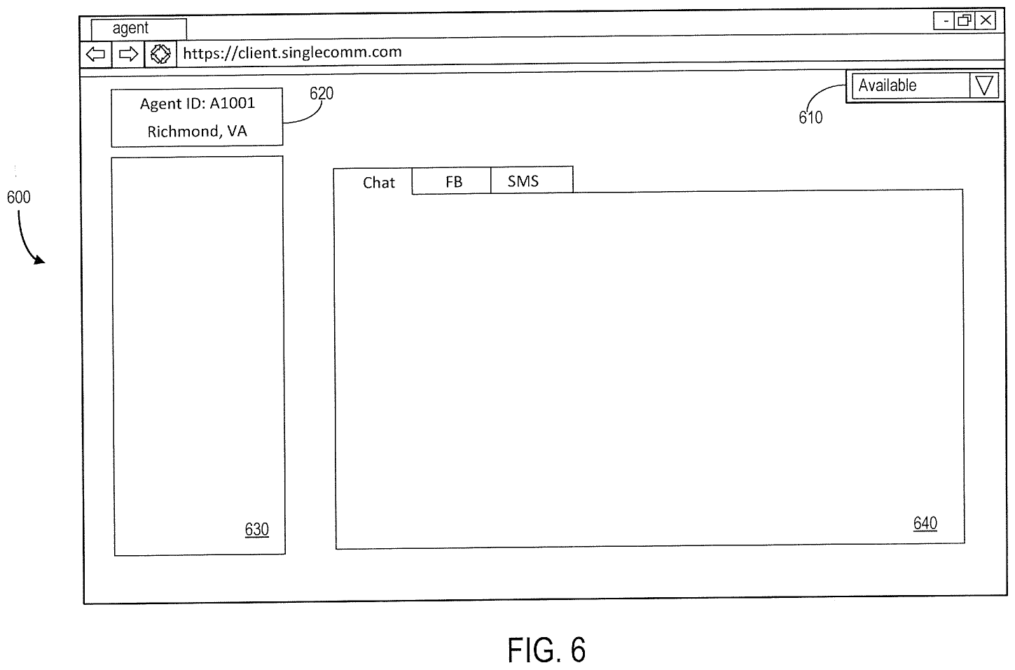

If processing at 206 determines that there is a job available that is suitable for the agent, processing continues at 208 where the system attempts to deliver the job to the agent for handling. Further details of such delivery will be provided further below in conjunction with a description of FIG. 6 as well as in discussions of FIGS. 3 and 4. If the job is successfully delivered, the status of the job may be updated to indicate that the job status is “accepted”.

If processing at 206 determines that there is no job available (or no job that the agent is suited for or that the agent has sufficient utilization availability for) processing may continue at 210 where the system attempts to identify one or more secondary jobs that are available. In some embodiments, some types of jobs are considered to be of higher priority than other (“secondary”) types of jobs. As an illustrative example, a call center may determine that inbound phone calls are the primary type of jobs (or the jobs that have the greatest weight). The call center may determine that outbound calls (e.g., calls initiated by an agent) are “secondary”. In such a situation, when an agent becomes available at 202, the system first attempts to identify an inbound call suitable for the agent. If that is not possible, the system then tries to identify a secondary job (an outbound call) that can be handled by the agent.

If processing at 212 determines that a secondary job is available for the agent, processing continues at 214 where the system attempts to deliver the secondary job to the agent for handling. Further details of such delivery will be provided further below in conjunction with a description of FIG. 6 as well as in discussions of FIGS. 3 and 4. If the job is successfully delivered, the status of the secondary job may be updated to indicate that the job status is “accepted”.

If no job is found (i.e., processing at 206 results in a “no” and processing at 212 also results in a “no”), processing continues at 204 as the system attempts to continue to find a job for the agent whose utilization has changed. This may continue until a job is found or the agent's status changes to a status in which the agent is no longer available to take a job.

Reference is now made to FIG. 3 where a further flow chart is shown depicting a further process 300 that may be performed by the system 100. The process 300 begins at 302 where the platform 102 (e.g., through presence manager 104) identifies a utilization change event associated with an agent (similar to step 202 of the process 200 of FIG. 2). Processing continues at 304 where the platform 102 (e.g., through job manager 104) searches for an available job. The available job may be one from a number of jobs that have been queued, for example. An available job may be one that has not been assigned to another agent (e.g., does not have a status=“accepted”) and that hasn't already been handled or suspended.

Processing continues at 306 where a determination is made whether any job was available. If no job was available, processing may continue to 308 where a secondary job is queued for the agent. In some embodiments, as described elsewhere herein, if a primary job (e.g., such as an inbound call) is not available, the system may be configured to deliver lower priority jobs (also referred to herein as “secondary” jobs) to an agent to increase the time that the agent is productively working on jobs. The secondary job is then delivered to the agent console (or Web browser) at 312 as will be discussed below. In some embodiments, the system may be configured to operate without secondary jobs. In that case, if no job is available at 306, processing may return to 304 where the system continues to await an available job (or until the agent status otherwise changes to eliminate the need for a job for that agent).

If processing at 306 indicates that a job is available, processing continues at 310 where a determination is made whether the job can be matched to the particular agent. In some embodiments, each agent may have a set of characteristics or skills. Those skills or characteristics may be checked at 310 to determine if they match the required skills or characteristics of the identified job. For example, the job may be one that requires Spanish language skills. If the agent does not have the skill of Spanish language, the job is not able to be matched to that agent and processing reverts to 304 where the platform again attempts to identify an available job. Further, the agent must have sufficient utilization available to handle the job (i.e., the agent's agent utilization must be greater than or equal to the job utilization value associated with the job).

If the agent is able to be matched to the job at 310, processing continues at 312 where the job is assigned to the agent and where the job details are delivered to the agent console. As used herein, the term “agent console” refers to an agent interface associated with an agent device 130 which the agent has logged into. In some embodiments, the agent console may simply be an agent device 130 configured with a Web browser pointed to a URI associated with platform 102 (e.g., as shown in FIG. 7 below). In some embodiments, the agent console may be an application (which likely also is configured with a Web browser pointed to a URI associated with platform 102) that runs on an agent device 130. The job details delivered to the agent console may be basic information about the job (such as a job identifier) which the agent console then uses to retrieve additional information, or it may be more detailed information that allows the agent console to perform processing to establish a connection to the job (e.g., in the case where the job is a phone call) or to retrieve a form (e.g., in the case where the job is a data entry task) or to navigate to a Web page or container to interact with a chat, email or messaging job.

Processing continues at 314 where the system operates to determine whether the agent console has properly accepted the job. In some embodiments, processing at 314 includes checking a status of the job as well as the status of the agent console in an attempt to determine if the job has properly been accepted. In some embodiments, these checks are performed by one or more watchdog processes 108 of platform 102. If processing at 314 indicates the job has properly been accepted, the status of the job is updated to indicate that it is has been “accepted” and processing continues at 316 where the watchdog process monitoring that specific job may be terminated. If, however, processing at 314 indicates that the job was not properly accepted, processing continues at 318 where the job is requeued. For example, in some situations, the agent console may have experienced a change in state before the job could be delivered. As another example, a network interruption may have occurred causing the job delivery to fail. In either event (or in other situations where the job has not been delivered), the watchdog process 108 will determine that the job was not delivered and will cause the job to be requeued and delivered to an appropriate agent that is available to handle the job. In this way, embodiments allow jobs to be distributed and have confirmation that the handoff or delivery of each job is performed properly, providing an improved experience for customers and agents even in systems where network or workstation difficulties cause intermittent disruptions of communication.

Reference is now made to FIG. 4 where a further flow chart is shown depicting a further process 400 that may be performed by the system 100. The process 400 begins at 402 where the platform 102 (e.g., through job manager 106) identifies a job requiring an agent to handle. For example, the job may be an inbound phone call that arrives at a phone switch associated with a communications application 112. Arrival of the call may generate a job identifier and information identifying the job and attributes of the job. For example, a call may have attributes such as the Dialed Number Identification Service (DNIS, or the phone number called by the caller) which can further be used to identify a campaign, and/or a program associated with the DNIS.

Processing continues at 404 where the job (identified by the job identifier) is placed in a queue (such as the queue 114) for handling. Those skilled in the art, upon reading this disclosure, will appreciate that a number of jobs may be placed in the queue for handling substantially at the same time during busy hours of operation. Processing continues at 408 where the job manager 106, operating on information from the queue, determines, for each job, whether an eligible agent is available to handle the job. Information about eligible agents is provided, in part, by the presence manager 104 (which provides information about the current status or presence of each agent logged into the platform). Information about eligible agents is also provided from one or more data stores (such as storage 118) which contain information about the skills, capabilities or other attributes of each agent as well as information about the agent's current agent utilization. Job manager 106 uses the information about the job, the information about the agent presence, status and utilization as well as the information about the agent skills, capabilities or other attributes to determine which agent a job should be assigned to. In situations where no eligible agent is currently available, a time out rule is consulted at 406 to determine if the time since creation of the job and the current time exceeds a time out threshold for that job. If the time out threshold has not been exceeded, processing continues at 408 and the job manager 106 again checks for an available agent.

If the time out threshold has been exceeded, processing continues at 412 where a process is executed to perform timeout handling. In some embodiments, time out handling rules may be configured differently for each campaign and/or program. For example, a time out handling rule may be created which specifies that if the job is not successfully delivered to an agent within one minute, that it will be routed to an external call center for handling. As another example, a rule may indicate that jobs not delivered to an agent within one minute will be delivered to a voice mail box or be delivered to another queue for expedited handling. If the time out handling rule is executed and a watchdog confirms that the rule was properly handled (e.g., the call was routed to an external call center, or the call was routed to a voice mail box, or the call was routed to another queue), then the status of the job is updated to indicate it was properly done (as well as information about the time out rule) and processing completes at 416. If, however, the timeout handling was not executed properly, the job may be requeued at 418.

If processing at 408 results in the job manager 106 finding an available agent, processing continues at 410 where the job is assigned to the agent and the job details are delivered to the agent console. Processing at 410 is similar to processing at 312 of FIG. 3. In general, the job details delivered to the agent console may be basic information about the job (such as a job identifier) which the agent console then uses to retrieve additional information, or it may be more detailed information that allows the agent console to perform processing to establish a connection to the job (e.g., in the case where the job is a phone call) or to retrieve a form (e.g., in the case where the job is a data entry task) or to navigate to a Web page or container to interact with a chat, email or messaging job.

Processing continues at 414 where the system operates to determine whether the agent console has properly accepted the job. In some embodiments, processing at 414 includes checking a status of the job as well as the status of the agent console in an attempt to determine if the job has properly been accepted. In some embodiments, these checks are performed by one or more watchdog processes 108 of platform 102. If processing at 414 indicates the job has properly been accepted, the status of the job is updated to indicate that it is has been “accepted” and processing continues at 416 where the watchdog process monitoring that specific job may be terminated. If, however, processing at 414 indicates that the job was not properly accepted, processing continues at 418 where the job is requeued. The process of FIG. 4 is repeated for each job received by the platform 102.

Reference is now made to FIG. 6, where portions of an illustrative agent interface 600 is shown. As shown, agent interface 600 is displayed on a screen of a computing device such as a personal computer or other device such as agent device 130 of FIG. 1. The agent interface 600 may also be displayed on other devices, such as a mobile phone, a tablet or the like. Agent interface 600 may be or include a collection of network resources delivered to the browser when the browser is directed to a URI associated with a system such as the system 102 of FIG. 1. For example, accessing the URI may cause an agent interface to be rendered using front end technologies such as HTML, CSS, jQuery and a Javascript framework (such as, for example, AngularJS or React) to provide a rich and dynamic experience to the agent. The network resources may also include resources associated with voice interactions conducted through the browser (e.g., such as resources associated with setting up a voice session using the WebRTC protocol). Other network resources may also be delivered, such as, for example, images, streaming data, event information, or the like. Typically, these resources are delivered in accordance with the hypertext transfer protocol (HTTP).

The agent interface 600 may include a number of sections or components including an agent status 610 (which will be described further below), agent information 620 (for presenting information identifying the agent as well as optionally agent location information or the like), a control panel 630 (for providing control components such as a dialpad for phone calls, e.g.) and an information area 640 (for presenting scripts, order information, or other information relevant to the job assigned to the agent). This example layout and combination of components is for illustrative purposes only—those skilled in the art, upon reading the present disclosure, will appreciate that other layouts and combinations of components may be used.

The agent status information 610 may be, for example, a drop down or other control that allows the agent (or the system) to indicate the agent's current status. A number of agent statuses may be used such as, for example, “unavailable”, “available”, “offline”, “break”, etc. These statuses may be used in conjunction with utilization data associated with the agent to determine whether the agent is capable of taking an addition job or jobs. For example, the agent statuses may be higher level indications of the agent's work status, while the granular information about the agent's utilization is determined by the system based on what jobs have actually been assigned to the agent and based on the agent's overall work status. Some of the agent statuses are entered into automatically by the system, while others are selected by the agent. For example, an agent who has just logged in for their shift may be automatically placed into an “unavailable” status but may then make themselves “available” when ready to receive or handle their first job. Pursuant to some embodiments, the agent status is communicated from the agent's browser 600 to system 102 via a Web socket connection.

As shown in FIG. 6, as an example, the information area 640 may include information identifying different jobs that have been assigned to the agent. In the illustrated example, the agent has three tabs each associated with a different job assigned to the agent—a chat interaction, a Facebook Messenger interaction, and an SMS messaging interaction. The agent may navigate between the three tabs to participate in each of the different interactions. Those skilled in the art, upon reading this disclosure, will appreciate that other user interface configurations may be provided to allow an agent to easily handle different jobs.

Reference is now made to FIG. 7 where a process 700 is shown for matching a job to an agent (which process may be used in conjunction with the processes described in FIGS. 2 and 3, for example). As shown, process 700 may begin at 702 where an available job is identified (i.e., a job that requires handling by an agent). The identification of the job may also include identification of the type of job as well as the job utilization value associated with the job. Processing continues at 704 where information about an available agent is reviewed to determine if that agent is qualified to handle the job (e.g., whether the agent has appropriate skills and permissions to handle the job). If not, a different agent may be identified for analysis. If so, a determination may be made at 706 whether the agent has sufficient utilization available to handle the job. That is, processing at 706 may include determining whether the agent's agent utilization is greater than the job utilization value associated with the job. If so, the job details are delivered to the agent console at 708 for the agent to handle. If not, a different agent or job are identified for processing.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems).

Moreover, some embodiments have been described herein as being accessed via a desktop computer. Note, however, that embodiments may be implemented using any device capable of executing the disclosed functions and steps. For example, in some embodiments, one or more agents may handle jobs distributed by the system of the present invention using mobile phones, laptops, tablet computers or the like.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

What is claimed:

1. A method comprising:
identifying a job to be delivered to an agent, the job having a job utilization value and the agent having an available agent utilization where the available agent utilization is greater than the job utilization value;
initiating a delivery process to deliver the job to the agent; and
delivering the job to the agent and reducing the available agent utilization by the job utilization value.

2. The method of claim 1, wherein the delivery process further comprises:
triggering a job monitoring process;
monitoring a status of the job and a status of the agent;
determining whether the job has been successfully delivered to the agent; and
completing the job monitoring process.

3. The method of claim 2, the delivery process further comprising:
establishing a timeout period for the job monitoring process; and
requeuing the job if the timeout period expires prior to determining whether the job has been successfully delivered to the agent.

4. The method of claim 3, wherein the available agent utilization is not reduced by the job utilization value if the timeout period expires prior to determining whether the job has been successfully delivered to the agent.

5. The method of claim 1, wherein the identifying a job to be delivered to an agent further comprises:
identifying a utilization change event associated with the agent; and
determining that the job is an available job that the agent is qualified to handle.

6. The method of claim 5, wherein the utilization change event is the completion of a job resulting in an increase in the agent's available agent utilization.

7. The method of claim 1, wherein the identifying a job to be delivered to an agent further comprises:
identifying a job requiring an agent;
determining that the agent is qualified to handle the job.

8. The method of claim 7, the method further comprising:
determining that a job is not available that the agent is qualified to handle; and
determining whether a secondary job is available that the agent is qualified to handle.

9. The method of claim 1, wherein delivering the job to the agent further comprises:
delivering the job to the agent via a Web browser associated with the agent.

10. The method of claim 8, wherein the job is a job having a higher priority than the secondary job.

11. The method of claim 10, wherein the job is an inbound call and the secondary job is an outbound call.

12. The method of claim 7, wherein the determination of whether the agent is qualified to handle the job is based at least in part on a skill of the agent.

13. The method of claim 7, wherein the determination of whether the agent is qualified to handle the job is further based at least in part on a campaign or a program identifier associated with the job.

14. The method of claim 5, wherein the utilization change event is a status change of the agent causing the agent to have available agent utilization.

15. The method of claim 14, wherein the status change of the agent is published via a web socket connection between the Web browser associated with the agent and a signaling service.

16. The method of claim 11, wherein the inbound call is delivered to the agent by establishing an audio connection to a Web browser associated with the agent and bridging the audio connection with a phone call received from a customer.

17. The method of claim 11, wherein the outbound call is delivered to the agent by establishing an audio connection to a Web browser associated with the agent and bridging the audio connection with an outbound call placed by a phone server to a customer.

18. The method of claim 16, wherein the bridging the audio connection with a phone call includes:
establishing a conference bridge;
joining the audio connection to the conference bridge; and
joining the phone call to the conference bridge.

19. The method of claim 1, wherein the job is one of (i) an inbound call, (ii) an outbound call, (iii) a chat message, (iv) an email, (v) a text message, and (vi) a task for the agent to complete in a Web browser.

20. The method of claim 17, wherein the audio connection is a connection following the WebRTC protocol.
